(19) United States
(12) Patent Application Publication
(10) Pub. No.: US 2016/0162706 A1
(43) Pub. Date: Jun. 9, 2016

(54) METHOD FOR PROCESSING GEOLOCATION DATA

(71) Applicant: INSTITUT MINES-TELECOM, Paris (FR)

(72) Inventors: Antonino Famulari, Messina (IT); Thomas Bonald, Voisins Le Bretonneux (FR)

(73) Assignee: Institut Mines-Télécom, Paris (FR)

(21) Appl. No.: 14/907,508

(22) PCT Filed: Jul. 28, 2014
(86) PCT No.: PCT/EP2014/066206

§ 371 Date: Jan. 25, 2016

(30) Foreign Application Priority Data
Jul. 26, 2013 (FR) 1357423

(51) Int. Cl. G06F 21/62; H04L 29/08; G06F 17/30; H04W 4/02

(52) U.S. Cl. CPC G06F 21/6254; H04W 4/02; H04L 67/1097; G06F 17/30241; G06F 17/30321

(57) ABSTRACT

The present invention relates to a method for processing geolocation data, including the implementation, by means for processing data from a server, of the steps of: (a) transmitting a geolocation request to a mobile terminal including geolocation means; (b) receiving geolocation data from the mobile terminal; (c) associating said geolocation data with a unique identifier, itself associated with the mobile terminal, in a database stored in data storage means; (d) receiving a geolocation request transmitted by an application server, the request including said unique identifier associated with the mobile terminal; (e) generating and sending, to the application server, a response to the request depending on the geolocation data associated with the unique identifier in said data base, and on the rules associated with the application server.

### GENERAL TECHNICAL FIELD

The present invention relates to a method for processing geolocation data.

### STATE OF THE ART

Modern mobile terminals of the smartphone type have geolocation capabilities, for example allowing navigation on a map, “check-in” points, i.e. the publication of the position of a user on social networks, as well as many other functionalities.

However, the significant increase in the number of applications benefiting from geolocation today shows two problems. First of all, present mechanisms do not allow fine managing of the confidentiality of the geolocation data. In most cases, the user only has the possibility of accepting or refusing full access by the application to the geolocation data, while it appears that it is not necessary to always disclose these data with the same fineness (accuracy of the geographical localization, updating frequency, etc.). For example, there exist applications using geolocation which only need to know whether a user A is in proximity to a user B, the knowledge of their position not being indispensable. The sending of too detailed information (in particular if it contains data giving the possibility of finding the identity of the user) generates a risk of illicit use of the data by the application, or even by a hacker making use of a safety fault of the application.

Next, significant energy consumption of mobile terminals is noticed, relating to the processing and the sending of geolocation data. Indeed, each application independently utilizes the geolocation data which it needs. When several applications using geolocation data operate at the same time on the same mobile phone, these data may be sent several times by this mobile telephone, towards each application server related to one of the applications. The operations for processing and transmitting associated data consume energy unnecessarily.

Many solutions have been proposed, in particular for solving the first problem (the one of confidentiality), for example the use on the terminal of an additional module for controlling geolocation data before transmission, or the use of a “proxy” server managing the authorizations for accessing the geolocation data, making the request anonymous, and notifying the user if need be (see patent application EP 1878283).

These solutions however do not solve the problem of energy consumption, and on the contrary worsen it: the mobile terminal is even more actuated.

More recently, in international application WO 2013/002927 mutualized managing of the check-ins has been proposed. In the described method, the geolocation data are transmitted to a trustworthy server, which sends back to the terminal processed data corresponding to different associated accuracy levels possible (for example, if the user is geolocated in an airport, the different levels may spread out from the specific number of the gate of the airport in which the user is found, as far as the general indication of the region in which the airport is located), for selection by the user and transmission to one or several application servers with view to one or several check-ins.

This method may slightly reduce the consumption in so far that a few processing operations are remotely managed.

However, it is seen that today check-ins represent a small portion of the energy consumption for geolocation purposes. Indeed, these are “tracking” mechanisms which consume the most the battery of the mobile phone. Tracking consists in repeated sending (for example every thirty seconds) of the position of the user so as to allow dynamic functionalities, for example the sending of a notification if the user passes close to a predetermined position (a centre of interest, a known person, a sign board, etc.).

A proposal which has been made for reducing the energy consumption related to tracking is a force reduction in the frequency of updating the geolocation data, which may be detrimental to the operation of certain applications.

Also from document U.S. 2011/0159884, a solution is known in which a server storing the position of the terminal is used as an interface for the various application servers, the terminal only transmitting its position to the intermediate server if it moves significantly. This solution only allows reduction in the energy consumption of the terminal in the case of reduced mobility.

It would be desirable to have a solution for managing geolocation data which guarantees confidentiality of the geolocation data and gives the possibility of substantially reducing the energy consumption of the terminals, this without altering the quality of the service.

### PRESENTATION OF THE INVENTION

The present invention thus relates to a method for processing geolocation data comprising the implementation by data processing means of a server for steps of:
(a) emitting a first geolocation request intended for a mobile terminal comprising geolocation means;
(b) receiving as a response geolocation data from the mobile terminal;
(c) associating said geolocation data in a database stored on the data storage means with a unique identifier itself associated with the mobile terminal;
(d) receiving a geolocation request emitted by an application server, the request comprising said unique identifier associated with the mobile terminal;
(e) generating and sending to the application server a response to the request depending on the geolocation data associated with the unique identifier in said database, and on rules associated with the application server.

The use of a trustworthy server for responding to requests sent by the application servers gives the possibility of both easily making the geolocation data anonymous and streamlining the actuation of the means for geolocation of the mobile terminals: if several applications require these data, it is sufficient to transmit them once to the server, and it is the latter which processes the multiple requests.

Moreover, this method only requires the implementation of a lightweight module on the terminal and facilitates the development of new applications using geolocation, in so far that it is sufficient to contact a unique server, the latter being able to manage complex requests providing advanced functionalities (for example, a request for notification if a certain event occurs).

According to other advantageous and non-limiting features:
said unique identifier is an anonymous identifier generated by the mobile terminal and received by the data processing means of the server during step (a);
said unique identifier is an anonymous identifier generated in step (b) by the data processing means of the server and sent to the mobile terminal;
said unique identifier is changed at regular intervals;
said unique identifier received by the mobile terminal is sent to the application server if the user allows the application of the server to access its geolocation data;
the geolocation data are also associated in said database with time data relating to the moment of their reception in step (b);
the method comprises a step (e1) of transmitting a first new request, for receiving updated geolocation data from the mobile terminal and then updating the database stored on the data storage means;
the method comprises the repetition of steps (d) and (e), in which the step (e1) is performed following each step (d) if the data processing means of the server determine according to rules associated with the application server having transmitted the second request that the geolocation data have to be updated;
the sequence of steps (d) and (e) is repeated at a given frequency for at least one application server, step (el)) being repeated at a frequency depending on the frequencies at which the sequence of steps (d) and (e) is repeated for an application server and/or of at least one rule associated with the application server;
according to a rule associated with the application server, the response generated in step (e) comprises a degraded version of the geolocation data associated with the unique identifier in said database;
the second request received in step (d) comprises reference geolocation data, according to a rule associated with the application server the step (e) comprises the comparison of the geolocation data associated with the unique identifier in said database with the referenced geolocation data, the generated response depending on the result of said comparison.

According to a second aspect, the invention relates to a server for processing geolocation data, connected to at least one mobile terminal, comprising geolocation means and to at least one application server, the server comprising data storage means and data processing means configured for implementing:
a module for transmitting a first geolocation request to the mobile terminal;
a first module for receiving geolocation data from the mobile terminal in response to the first request;
a module for association of said geolocation data in a database stored on the data storage means with a unique identifier itself associated with the mobile terminal;
a second module for receiving a second geolocation request transmitted by the application server, the second request comprising said unique identifier associated with the mobile terminal;
a module for generating and sending to the application server a response to the second request depending on the geolocation data associated with the unique identifier in said database, and of rules associated with the application server.

According to a third aspect, the invention relates to a system comprising:
at least one mobile terminal comprising geolocation means;
at least one application server;
at least one server according to the second aspect.

According to other advantageous and non-limiting features:
the mobile terminal implement a module for managing rules associated with each application server.

According to a fourth and fifth aspects, the invention relates to a computer program product comprising code instructions for executing a process according to the first aspect of the invention for treating geolocation data; and a storage means legible by a piece of computer equipment on which a computer program product comprises code instructions for executing a process according to the first aspect of the invention for processing geolocation data.

### PRESENTATION OF THE FIGURES

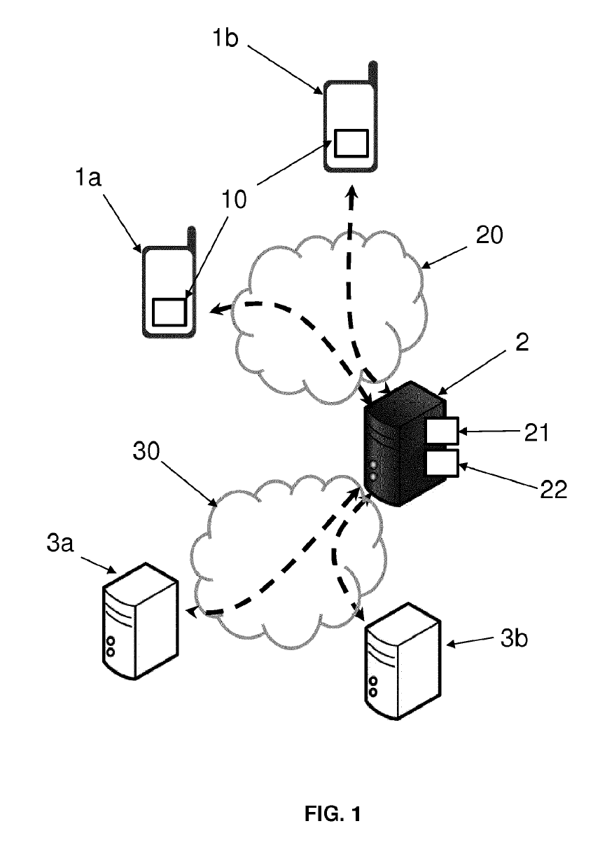

Other features and advantages of the present invention will become apparent from reading the description which follows of a preferential embodiment. This description will be given with reference to the appended FIG. 1 which represents an architecture for implementing the method according to the invention.

### DETAILED DESCRIPTION

### Internal Architecture

The present method for processing geolocation data is performed in an environment of the type of the one illustrated by FIG. 1.

One or several mobile terminals 1a, 1b are connected to a communications network 20 (in particular a mobile telephone network). Each mobile terminal 1a, 1b may be any piece of equipment capable of connecting to the communications network 20. For example this may be a smartphone, a touchscreen tablet, etc.

Each mobile terminal 1a, 1b comprises geolocation means 10, which may implement one of the numerous implemented geolocation techniques on mobile terminals (GPS, GSM positioning, RFID, etc.). It will be understood that the preceding method is by no means limited to obtaining on the mobile terminal 1a, 1b location data, and that the means 10 may assume any shape (physical and/or software shape).

A server 2 is connected to the communications network 20. This is a “trustworthy” server, notably a server of the operator of the network 20. It conventionally comprises a data processing module 21 (a processor) and a data storage module 22 (for example a hard disc).

This server 2 is itself for example connected via the Internet network 30 to one or several application servers 3a, 3b. These are servers involved in the operation of an application (for example one or several servers of a social network), at the origin of request for geolocation data transmitted and intended for the terminals 1a, 1b.

It should be noted that there may be several servers 2, each connected to one or several application servers 3a, 3b.

### Principle

The Applicant noticed that today it is common that several applications simultaneously use the geolocation data of a mobile terminal, a fortiori in a tracking mode. For example, it is possible that the user is using a first application of the “map” type displaying a map on which the position of the user is displayed, while, as a background task, certain applications, for example designed for sending a notification if the user is in proximity to a friend, a restaurant, etc., operate.

The application server of each of these applications “tracks” the position of the user, i.e. it requires (optionally at regular intervals), the location data of his/her mobile terminal 1a, 1b.

If each of these applications has a given frequency for updating the geolocation data, it is ascertained that the actual frequency for actuating the geolocation means 10 is equal to the sum of these frequencies, whence the consequent increase in the energy consumption as soon as several tracking operations are simultaneously active.

Now, actuating as many times the geolocation means 10 as there are applications proves to be unnecessary. The present method thus proposes a way for avoiding any redundancy in the managing of geolocation data, by means of a trustworthy server 2.

Further, instead of operating in a “push” mode in which it is the terminal 1a, 1b which decides when geolocation data are sent to the server (it “pushes” the data), the present server 2 implements a so called “pull” operating mode in which it is it which explicitly requests the position of the terminal when it is appropriate (the server “pulls” the data), the latter being contented with answering. In other words, the intelligence (as regards the managing of the geolocation) of the terminal 1a, 1b is at least partly moved towards the trustworthy server 2. In known methods of the type of the one described in document U.S. 2011/0159884, the server 2 exclusively operates in the push mode.

This gives the possibility of further improving battery savings. First of all, this gives the possibility of guaranteeing that no geolocation request is made for nothing, even if the terminal would be in motion. Next, this gives the possibility of many clever additional savings. For example, if the server 2 is aware that a terminal should be found in a certain area (for example by means of the histories of the position of the mobile) but does not have its specific present position, it only has to make a pull request for having the exact position of the mobile if an event of interest for the user occurs in this area (presence of a known person, request of information from a third party, possible car pooling, commercial offer, etc.). Geolocation is therefore only requested rightfully, from information not available for the terminal 1a, 1b, which is a clear difference with the push solution. The consumption of the battery is thus further optimized. And if the actual position of the terminal 1a, 1b is not the intended one, this does not matter, the stored information may be reused by other applications.

In a first step (a), the data processing means 21 of the server 2 transmit to the mobile terminal a first geolocation request (this is the pull request). As a reply, in a step (b) these data processing means 21 receive from the mobile terminal 1a, 1b geolocation data (obtained by the geolocation means 10). This sending has the particularity of not being performed in response to a request from an application. It only aims at providing these data to the server 2 with view to storage. As this will be seen later on, this first request may follow, or on the contrary precede a second request stemming exactly from an application server 3a, 3b.

In a step (c), these data are associated in a database stored on the data storage means 22 of the server 2, with a unique identifier itself associated with the mobile terminal 1a, 1b.

Preferably, the geolocation data are also associated in this database with time data (typically the time) relative to the moment of their reception in step (b).

Thus, the database of the server 2 consists of triplets of the type (identifier, geolocation data, time). Many terminals 1a, 1b may be managed within a single database.

This single identifier is an anonymous identifier which may either be generated by the data processing means 21 of the server 2 and sent to the mobile terminal 1a, 1b (during step (b)), or generated by the mobile terminal 1a, 1b, which directly sends the pair (identifier, data) to the server 2 in step (b). The unique identifier gives the possibility of making the geolocation data anonymous by avoiding that the latter be referenced via data allowing direct identification of the terminal 1a, 1b or its user.

Only the trustworthy server 2 is optionally capable of making the link between a unique identifier and the real identity of the user, which guarantees confidentiality of the geolocation data. In the case when it is the terminal 1a, 1b which generates (and changes) the identifier, it is possible to ensure that the server 2 is not able to relate the old and the new identifier, since it directly receives a new pair (identifier, data), which it may interpret as representing a new terminal. This increases the confidentiality, but it may be desirable to avoid this if for example an application uses past positions of the terminal 1a, 1b.

In every case, for optimum security, the unique identifier may be changed (i.e. regenerated by the server 2/the terminal 1a, 1b) at regular intervals, for example every hour.

The “present” unique identifier of the mobile terminal 1a, 1b is sent to the application server 3a, 3b (so that the latter may designate the terminal 1a, 1b) if the user allows the application server 3a, 3b to access his/her geolocation data. This authorization may be given via a software module implemented on the terminal 1a, 1b (which will be described in more detail further on). The sending may be achieved either by the terminal 1a, 1b, or by the server 2. If the identifier has been transmitted, the server 2 may receive in a step (d) a second geolocation request transmitted by the application server 3a, 3b, the second request comprising said unique identifier associated with the mobile terminal 1a, 1b (as well as additional data which will be described later on). It should be noted that step (d) may, if necessary, precede one or several of the steps (a) to (c). Indeed, step (d) and the steps (a) to (c) are independent and the server 2 does not control the arrival time of the second requests.

The data processing means 21 of the server 2 will then generate and sent to the application server 3a, 3b (in a step (e)) a response to the second request depending on the geolocation data associated with the unique identifier in said database, and on rules associated with the application server 3a, 3b.

The steps (d) and (e) take place as many times as second requests are sent to the server 2. As this will be seen later on, each second request may give rise or not to updating of the geolocation data (in other words, the sending of a first request).

Thus, in the present method, it is the trustworthy server 2 which receives the second requests and which replies to them. None of the second request is transmitted to the terminal 1a, 1b. The latter only sees the first requests (which are in practice much less numerous than the second requests because of the intelligence of the server 2) and is thus not actuated unduly.

This gives the possibility:
of guaranteeing the confidentiality since the data are made anonymous on the one hand and the generated response may be “degraded” or be limited to certain less confidential pieces of information if the associated rules provide this on the other hand. All the exchanges (between terminals and trustworthy server, application servers and trustworthy server) may moreover be encrypted in order to prevent any interception by a third party piece of equipment.
of substantially reducing the energy consumption, since:
   a single sending of geolocation data by the terminal 1a, 1b on the one hand may be utilized by a plurality of application servers 3a, 3b, the energy cost for generating one response per request being carried over to the server 2. In other words, the present method provides the single access to applications, allowing the mobile terminal 1a, 1b to only send once its geographical position, this information being available for all the applications. The energy consumption related to geolocation becomes independent of the number of active applications;
   the terminal 1a, 1b on the other hand is actuated to the strict minimum by the filtering cleverly operated by the server which transforms a large number of second requests into a small number of first requests, or tunes the initiative of the first request when this is appropriate.

### Updating the Data

The geolocation data associated with a particular mobile terminal 1a, 1b in the database are rapidly obsolete, since the user continues to move. It is therefore necessary to update them regularly, a fortiori if an application operates in a tracking mode (and therefore that the associated application server 3a, 3b has to receive updates at regular intervals).

The method thus advantageously comprises a step (el) of transmitting a new first request for receiving geolocation data updated from the mobile terminal 1a, 1b and then for updating the database stored on the data storage means 22. The step (e1) is equivalent to a repetition of the steps (a) to (c), i.e. to the transmission of a new first request.

It should be noted that this update is not necessarily a replacement of data stored previously. If the geolocation data are associated with a time parameter, it is possible to generate a new entry in the database. Generally, this will be the most recent entry for a unique given identifier which will be used (even if as explained, the idea may occur that the knowledge of older geolocation data may be interesting for certain applications).

The step (e1) may take place before or after the step (e). In a first embodiment, every time a second request is received (step (d)), the server 2 determines whether triggering step (e1)) is required, according to rules associated with each application server 3a, 3b and to parameters such as the “age” of the data. These rules for example may define a time threshold beyond which the data are considered as obsolete and have to be updated, whence a consecutive number of second requests. In other words, at each second request, the server 2 replies directly (step (e1)) is not performed) if it is able to do so (the information is there) or goes back if necessary (the information is missing or obsolete). In this embodiment, each optional occurrence of step (e1)) is inserted between step (e) and step (d).

In a second embodiment, the server 2 has the initiative and may, independently of the receptions of the second requests, update the geolocation data (step (e1)) is performed after step (e) and before an optional step (d)). For example, a shop wants to be informed when potential customers are in proximity to its shops; it is then the server 2 which notifies the application server 3a, 3b when this is the case. For this, it may query the mobiles on its own initiative (pull request), when for example the history of the data suggests that such a potential customer should be in proximity to such shop.

In a tracking case, the second requests are sent at a given frequency (tracking frequency), in other words, the frequency at which the sequence of steps (d) and (e) is repeated for at least one application server 3a, 3b.

The updating frequency may in such a case be set by the server 2 and defined as the one set by the most constraining application: instead of using rules and/or reacting to each reception of a second request, step (e1)) is repeated at a frequency equivalent to the highest frequency from among the frequencies at which the sequence of steps (d) and (e) is repeated for an application server 3a, 3b.

In the absence of applications in a tracking mode (in other words applications imposing a given updating frequency), the effective frequency may alternatively depend on other criteria such as the time or the position of the mobile, according to the access rules defined by the user (see hereafter).

As an example, if an application A requests an accuracy of 50 m on the localization of the terminal 1a, 1b and an application B an accuracy of 500 m, the position will be sent with an accuracy of 50 m for ensuring proper operation of application A, and the updating will be requested as soon as the actual position differs from more than 50 m from the last sent position.

It should be noted that the different modes for updating the data mentioned above may be performed in turn or as a combination depending on the different application servers 3a, 3b requiring geolocation.

Generally, it will be understood that the geolocation means 10 never transmit an unnecessary update (i.e. which cannot be utilized by an application) in order to preserve at most the battery of the mobile terminal 1a, 1b. The frequency may therefore be optimized permanently by the data processing means 21 of the server 2.

### Rules and Managing Module

The generation of responses may depend on other rules associated with the application servers 3a, 3b, these rules may moreover be managed at the mobile terminal 1a, 1b by a specific module.

As explained earlier, this module gives the possibility for any application of first of all defining an authorization or not for accessing the geolocation data. If the authorization is given, the server 2 may transmit to the associated application server the unique identifier of the terminal 1a, 1b (which makes reception and processing of requests possible by the server 2).

Next, this module defines the rules, which may be generally seen as managing rules, i.e. modulations on the level of access to the geolocation data, and on optional additional processing operations, to be compared with the rules related to the updating of the data (step (e1)).

For example, a managing rule may allow an application to only access these data with a certain time and space accuracy, this accuracy level may depend on the time and on the position of the mobile terminal 1a, 1b. The server 2 may then be entrusted to “degrade” the data by adding an unknown on the exact position and the instant at which this position was recorded. A maximum frequency of the requests of the application may also be defined.

Moreover, rules may provide the possibility of answering a second request other than transmitting geolocation data. For example, by providing that the request received in step (d) comprises reference geolocation data, step (e) may comprise the comparison by the data processing means 21 of the server 2 of the geolocation data associated with the unique identifier in said database with the reference geolocation data, the generated response depending on the result of said comparison (this is for example an answer to the question “is the terminal at less than 100 meters from such a position?”).

The use of the trustworthy server 2 thus gives the possibility of contemplating a direct answer to complex requests, which facilitates the work of developers (possibility of “pre-processing operations” in the server 2, with responses elaborated and obtained at the end of step (e), which may be directly used in the applications), while increasing the confidentiality level (possibility of directly answering the complex requests of application servers 3a, 3b without finally disclosing the actual position of the user).

The software module may be implanted in the operating system of the mobile terminal 1a, 1b or as an independent application, which may be activated by the applications using geolocation data.

If there are several trustworthy servers 2, the managing module may play an additional role. A user may actually resort to servers 2 either active at the same time (with updates for each server) or alternatively: the software module may, by notifying the applications, change server 2 or request a change in unique identifier in order to reinforce anonymity of the data of the user. There may be a default trustworthy server 2 (for example, managed by the manufacturer of the operating system), which is configurable by the user.

It should be noted that standard procedures exist for transmitting geolocation data and the rules for accessing these data (see for example the GEOPRIV group of IETF), the present method will not be limited to any of them.

### Server

The invention also relates to the trustworthy server 2 for implementing the method described earlier.

This server 2 is therefore connected to at least one mobile terminal 1a, 1b comprising geolocation means 10 and at least one application server 3a, 3b. It comprises data storage means 22 and data processing means 21.

The latter are configured for implementing:
a module for transmitting a first geolocation request to the mobile terminal 1a, 1b;
a first module for receiving geolocation data from the mobile terminal 1a, 1b in response to the first request;
a module for associating said geolocation data in a database stored on the data storage means 22 with a unique identifier itself associated with the mobile terminal 1a, 1b (this module also giving the possibility of generating the unique identifier, and if necessary the updating of the geolocation data in the database);
a second module for receiving a second geolocation request transmitted by the application server 3a, 3b, the second request comprising said unique identifier associated with the mobile terminal 1a, 1b;
a module for generating and sending to the application server 3a, 3b a response to the second request depending on the geolocation data associated with the unique identifier in said database, and rules associated with the application server 3a, 3b.

The invention moreover relates to the system which comprises this server 2, at least one mobile terminal 1a, 1b comprising the geolocation means 10 and at least one application server 3a, 3b.

As explained, the mobile terminal(s) 1a, 1b advantageously implement(s) (via specific data processing means) a module for managing the rules associated with each application server 3a, 3b (which also optionally allows activation/deactivation of the access rights to the geolocation data for the application servers 3a, 3b, and commands related to the server 2 such as the possibility of regenerating a unique identifier).

### Computer Program Product

According to a fourth and fifth aspects, the invention relates to a computer program product comprising code instructions for executing (in particular on the data processing module 21 of the server 2) a method according to the first aspect of the invention for processing geolocation data, as well as storage means legible by a piece of computer equipment (for example a data storage module 22 of the server 2) on which this computer program product is found.

1. A method for processing geolocation data comprising the implementation by data processing means of a server of steps of:
(a) transmitting a first geolocation request to a mobile terminal comprising geolocation means;
(b) receiving as a response geolocation data from the mobile terminal;
(c) associating said geolocation data in a database stored on data storage means with a unique identifier itself associated with the mobile terminal;
(d) receiving a second geolocation request transmitted by an application server, the second request comprising said unique identifier associated with the mobile terminal;
(e) generating and sending to the application server a response to the second request depending on the geolocation data associated with the unique identifier in said database, and on rules associated with the application server.

2. The method according to claim 1, wherein said unique identifier is an anonymous identifier generated by the mobile terminal and received by the data processing means of the server during step (a).

3. The method according to claim 1, wherein said unique identifier is an anonymous identifier generated in step (b) by the data processing means of the server and sent to the mobile terminal.

4. The method according to one of claims 2 and 3, wherein said unique identifier is changed at regular intervals.

5. The method according to one of claims 2 and 3, wherein said unique identifier received by the mobile terminal is sent to the application server if the user allows the application server to access to its geolocation data.

6. The method according to claim 1, wherein the geolocation data are also associated in said database with time data relating to the instant of their reception in step (b).

7. The method according to claim 1, comprising a step (e1) of transmitting a new first request, for receiving updated geolocation data from the mobile terminal and then for updating the database stored on the data storage means.

8. The method according to claim 7, comprising the repetition of steps (d) and (e), wherein the step (e1) is performed following each step (d) if the data processing means of the server determine according to rules associated with the application server having transmitted the second request that the geolocation data have to be updated.

9. The method according to claim 7, wherein the sequence of the steps (d) and (e) is repeated at a given frequency for at least one application server, step (e1) being repeated at a frequency depending on the frequencies at which the sequence of the steps (c) and (d) is repeated for an application server and/or on at least one rule associated with the application server.

10. The method according to claim 1, wherein according to a rule associated with the application server the response generated in step (e) comprises a degraded version of the geolocation data associated with the unique identifier in said database.

11. The method according to claim 1, wherein the second request received in step (d) comprises reference geolocation data, according to a rule associated with the application server, step (e) comprising the comparison of the geolocation data associated with the unique identifier in said database with the reference geolocation data, the generated response depending on the result of said comparison.

12. A server for processing geolocation data, connected to at least one mobile terminal comprising geolocation means and to at least one application server, the server comprising data storage means and data processing means configured so as to implement:
a module for transmitting a first geolocation request to the mobile terminal;
a first module for receiving geolocation data from the mobile terminal in response to the first request;
a module for associating said geolocation data in a database stored on the data storage means with a unique identifier itself associated with the mobile terminal;
a second module for receiving a second geolocation request transmitted by the application server, the second request comprising said unique identifier associated with the mobile terminal;
a module for generating and sending to the application server a response to the second request depending on geolocation data associated with the unique identifier in said database, and on rules associated with the application server.

13. A system comprising:
at least one mobile terminal comprising geolocation means;
at least one application server;
at least one server according to claim 12.

14. The system according to claim 13, wherein the mobile terminal implement a module for managing the rules associated with each application server.

15. A computer program product comprising code instructions for executing a method according to claim 1 for processing geolocation data, when this program is executed by a computer.

16. A storage means legible by a piece of computer equipment on which a computer program product comprises code instructions for executing a method according to claim 1 for processing geolocation data.
